(19) United States
(12) Patent Application Publication
(10) Pub. No.: US 2013/0186792 A1
(43) Pub. Date: Jul. 25, 2013

(54) Tab Bag

(71) Applicant: Liam Weisner, Shirley, NY (US)

(72) Inventor: Liam Weisner, Shirley, NY (US)

(21) Appl. No.: 13/750,065

(22) Filed: Jan. 25, 2013

Related U.S. Application Data
(60) Provisional application No. 61/590,439, filed on Jan. 25, 2012.

(51) Int. Cl. G06F 1/16

(52) U.S. Cl. CPC G06F 1/1628
USPC 206/320; 190/109; 190/110; 190/124

(57) ABSTRACT

A protective bag is disclosed that allows users to tote their tablet computers and other electronic devices safely. The protective bag typically comprises a detachable tablet case, which fits into the protective bag and may be secured to the bag with straps, or any other securing means. The detachable tablet case houses a tablet computer or other similar electronic device. Furthermore, the protective bag folds in such a way that a user may use the tablet computer while it is still attached to the protective bag. The protective bag can also comprise legs that can be folded out to allow the protective bag to stand upright when in use.

### CROSS-REFERENCE

This application claims priority from Provisional Patent Application Ser. No. 61/590,439 filed Jan. 25, 2012.

### BACKGROUND

Tablet computers and other similar electronic devices are typically powerful, expensive devices that are extremely lightweight, thin and portable. Because of their size, the tablet computers and other similar devices are vulnerable to damage when shoved in a purse or backpack, or other means of transportation. If the tablet computers and other similar devices should become damaged, the devices can be expensive to repair and/or replace. A solution is necessary to better protect tablet computers and other similar devices.

There is a need for a protective bag that allows an individual to safely transport his or her tablet computer or other electronic device. The protective bag has two parts; a detachable tri-fold tablet case and a messenger type bag. The tri-fold tablet case fits into the protective bag and may be secured inside with elastic straps. The protective bag folds in such a way that a user may use the tablet computer while it is still attached to the protective bag. This unique protective bag is ideal for anyone who needs a stylish and functional way to protect their tablet computers while on the go.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a protective bag that allows users to transport and use their tablet computers and other electronic devices safely. The protective bag typically comprises a detachable tablet case, which fits into the protective bag and may be secured on the bag with straps, or any other securing means. The detachable tablet case houses a tablet computer or other similar electronic device. Furthermore, the protective bag folds in such a way that a user may use the tablet computer while it is still attached to the protective bag.

In a preferred embodiment, the protective bag further comprises legs that can be folded out for use. The back surface of the protective bag typically comprises at least one leg that allows the protective bag to stand generally upright when in use. The legs can be folded into the back surface of the protective bag for storage and unfolded when in use. The legs would be secured to the protective bag via a hinge, or any other suitable pivot mechanism as is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of the protective bag with the tablet case secured inside in accordance with the disclosed architecture.

FIG. 2 illustrates a side perspective view of the protective bag and tablet case with a strap and fold-out legs in accordance with the disclosed architecture.

FIG. 3 illustrates a back perspective view of the protective bag with the legs folded out for use in accordance with the disclosed architecture.

FIG. 4 illustrates a side perspective view of the protective bag with the legs folded out for use in accordance with the disclosed architecture.

FIGS. 5A-B illustrate a perspective view of the protective bag and tablet case in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a protective bag that allows users to transport and use their tablet computers and other similar electronic devices safely. The protective bag can hold and protect a tablet computer or other electronic device while it's being used, or it can safely transport the same. This unique protective bag is ideal for anyone who needs a stylish and functional way to protect their tablet computers or other similar electronic devices while on the go.

Specifically, the protective bag comprises a detachable tablet case that can house a tablet computer or other similar electronic device. The detachable tablet case fits into the protective bag and may be secured on the bag with straps, or any other securing means. Further, the protective bag can also comprise legs that can be folded out to allow the protective bag to stand upright when in use.

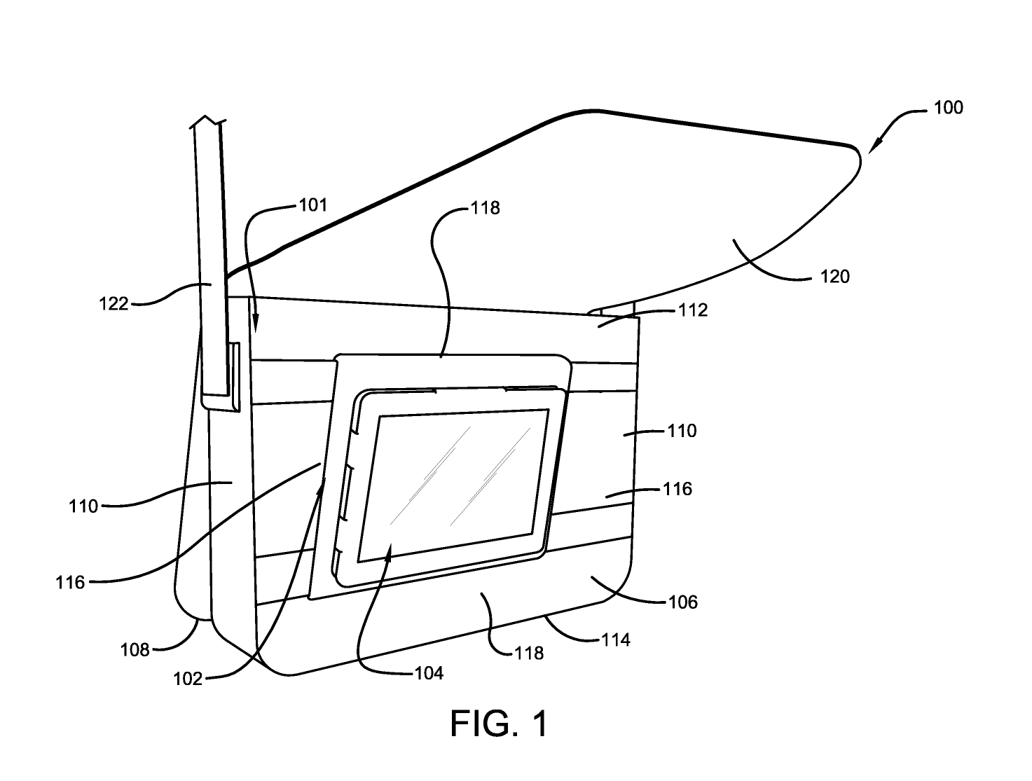

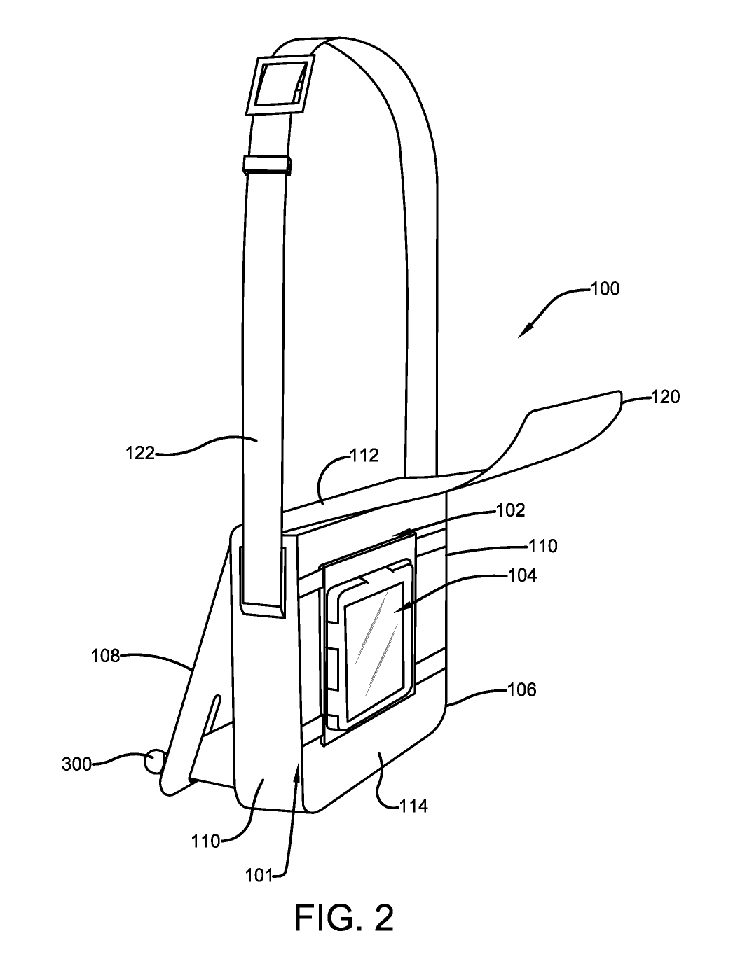

Referring initially to the drawings, FIGS. 1-2 illustrate a protective bag 100 that allows users to tote their tablet computers 104 and other electronic devices safely. The protective bag 100 typically comprises a detachable tablet case 102, which fits on the body 101 of the protective bag 100 and may be secured to the bag 100 with straps, or any other securing means. Further, the protective bag 100 folds in such a way that a user may use the tablet computer 104 while it is still attached to the protective bag 100.

The protective bag 100 comprises a body 101 which typically comprises a front surface 106, a back surface 108, two side panels 110, a top portion 112 and a bottom portion 114, wherein the front surface 106 receives a tablet computer 102 or other electronic device and allos the tablet computer 102 to be viewed and utilized by a user. Typically, the protective bag 100 is generally rectangular in shape, however any other suitable shape can be used as is known in the art without affecting the overall concept of the invention, as long as the body 101 of the protective bag 100 is shaped and sized to accommodate a tablet computer or other similarly shaped electronic device. Further, the protective bag 100 is usually a messenger type bag, but can be any suitable type of bag as is known in the art without affecting the overall concept of the invention, such as a backpack or other similar bag.

The protective bag 100 would generally be constructed of cloth, leather, nylon, or a polyvinyl chloride (PVC), etc., though any other suitable material may be used to manufacture the protective bag 100 as is known in the art without affecting the overall concept of the invention. The protective bag 100 can also comprise a variety of colors and designs to suit user preference. The protective bag 100 is approximately between 8 and 10 inches wide as measured from opposing side panels 110, and approximately between 2.5 and 5 inches deep as measured from the front surface 106 to the back surface 108, and approximately between 14 and 16 inches high as measured from the bottom portion 114 to the top portion 112. Typically, the pair of side panels 110 are substantially identical in height, but do not have to be and the protective bag 100 can function without the side panels 110 being identical in height.

The front surface 106 of the bag 100 allows a tablet computer 102 to be secured between the opposing side panels 116 and between the opposing top and bottom panels 118. The front surface 106 is such that a tablet computer 102 or other electronic device properly positioned on the body 101 of the protective bag 100 can be viewed and utilized by a user.

The body 101 of the protective bag can also comprise elastic bands, hook and loop fasteners, etc., or any other suitable securing means to removably secure the tablet computer 104 to the body 101 of the protective bag 100, such that the tablet computer 104 can be viewed and utilized by a user.

Further, the protective bag 100 can comprise a flap 120 that folds over the top portion 112 and the front surface 106 to conceal the tablet computer 104 or other electronic device from view. The flap 120 can comprise a securing mechanism for securing the flap 120 to the front surface 106. The securing mechanism being a snap, a hook and loop fastener, a buckle, a button, etc., or any other suitable securing mechanism as is known in the art.

The protective bag 100 further comprises a handle or strap 122 attached to the two side panels 110 for transporting the protective bag 100. Strap 122 can be any standard strap as is known in the art and functions as a typical prior art strap to allow a user to transport the protective bag 100 easily and efficiently. Strap 122 is typically attached to the side panels 110, but can be secured to any part of the protective bag 100 without affecting the overall concept of the invention. Strap 122 is secured to the protective bag 100 via sewing, attachment via a metal ring, fastening with hardware, etc., or any other suitable securing means as is known in the art.

Furthermore, the bottom portion 114 of the protective bag 100 can comprise at least one compartment (not shown) for housing a battery pack or other accessories, and/or allowing access to a universal serial bus (USB) port on the tablet computer 104 or other electronic device.

Additionally, the protective bag 100 can comprise a detachable tablet case 102 for housing and protecting the tablet computer 104 or other similar electronic device. Typically, the tablet case 102 is configured to be positioned on the body 101 of the protective bag 100 and comprises at least one panel (not shown) for supporting and/or protecting the tablet computer 104. Typically, the tablet case 102 comprises three panels though any suitable number of panels can be used without affecting the overall concept of the invention.

If three panels are utilized, then the middle panel comprises a frame and an elastic border, wherein the tablet computer 104 slides behind the frame and is secured in place via the elastic border or other suitable securing means. The two remaining panels are each secured to an edge of the middle panel, on opposing sides. The two panels fold over the front of the tablet computer 104 protecting and concealing the screen of the tablet computer 104, and can be secured together via hook and loop fasteners, snaps or any other suitable securing means as is known in the art. Further, the two panels can also fold backward, behind the tablet computer 104 and be secured together via hook and loop fasteners, snaps or any other suitable securing means as is known in the art.

The two panels can then be secured to the protective bag 100, allowing the tablet case 102 to be removably secured to the body 101 of the protective bag 100. Further, the body 101 of the protective bag can also comprise elastic bands, hook and loop fasteners, etc., or any other suitable securing means to further removably secure the tablet case 102 to the body 101 of the protective bag 100, such that the tablet computer 104 can be viewed and utilized by a user.

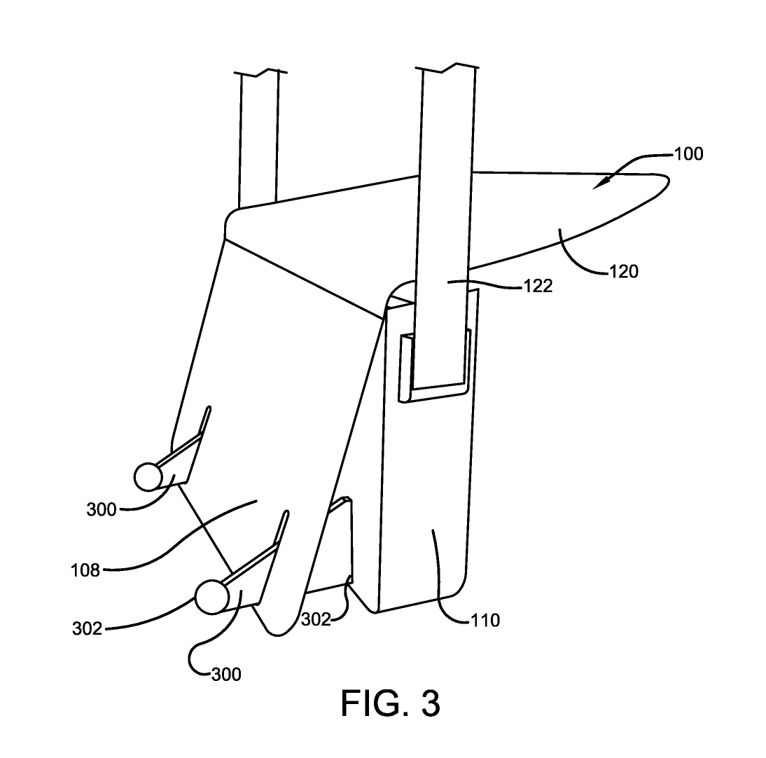

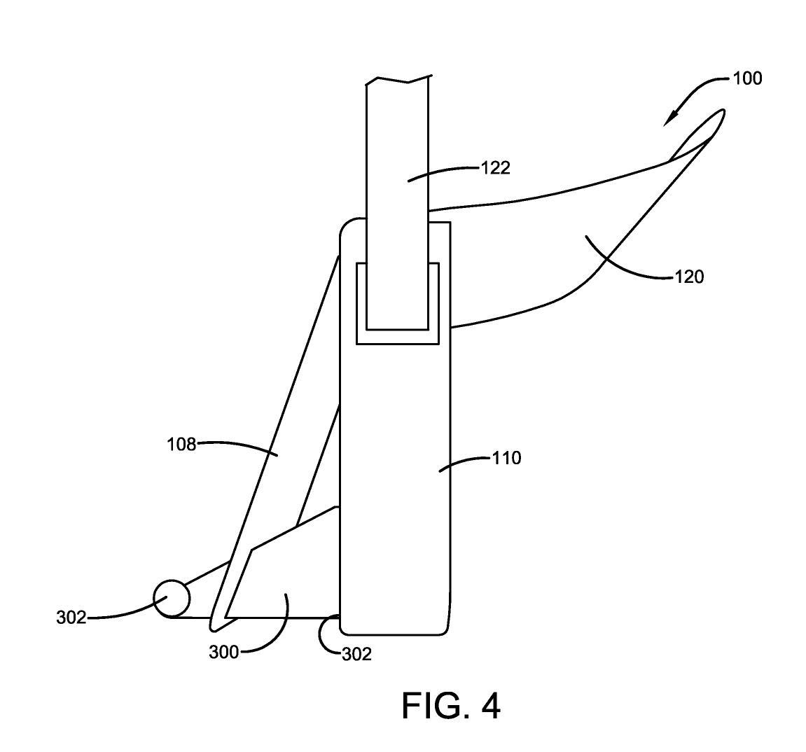

FIGS. 3-4 illustrate the protective bag 100 with the legs 300 folded out for use. The back surface 108 of the protective bag 100 typically comprises at least one leg 300 that allows the protective bag 100 to stand upright when in use. In a preferred embodiment, the protective bag 100 comprises two legs 300 secured to the back surface 108 of the protective bag 100, but any suitable number of legs can be utilized and the legs 300 can be secured to any part of the protective bag 100. The legs 300 can be folded up into the back surface 108 of the protective bag 100 for storage and unfolded when in use. The legs 300 would be secured to the protective bag 100 via a hinge, or any other suitable pivot mechanism as is known in the art. The hinge or other suitable pivot mechanism allows the legs 300 to be folded upwards for storage and folded down when in use.

The legs 300 would generally be constructed of aluminum, steel, magnesium, or a composite plastic, etc., though any other suitable material may be used to manufacture the legs 300 as is known in the art without affecting the overall concept of the invention. The legs 300 can also comprise a variety of colors and designs to suit user preference. The legs 300 are approximately between 4 and 7 inches long as measured from opposing ends 302 when fully extended.

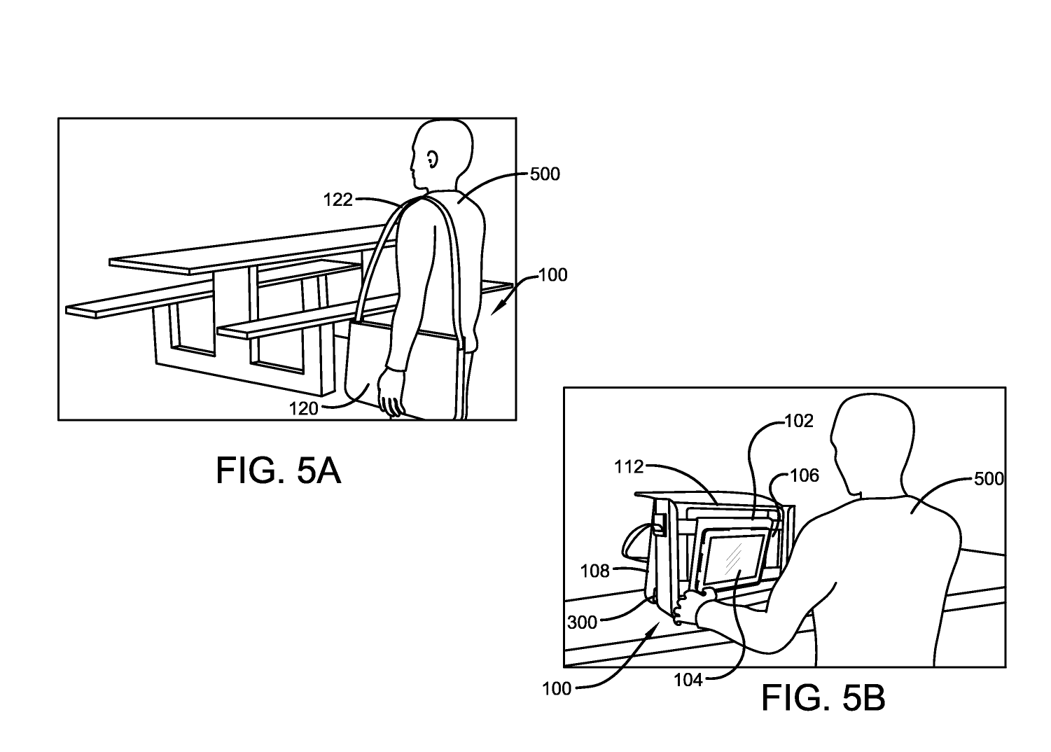

FIGS. 5A-B illustrate the protective bag 100 and tablet case in use. Specifically, FIG. 5A illustrates a user 500 transporting a tablet computer via the protective bag 100 and FIG. 5B illustrates a user 500 utilizing the tablet computer 104 while it is still attached to the protective bag 100. In operation, a user 500 would choose the color and/or specific design of the protective bag 100 that meets their needs and/or wants. The user 500 would then unlatch and open the flap 120 of the protective bag 100, exposing the body of the protective bag 100. A user 500 would then remove the tablet case 102 from the interior of the protective bag 100 and open the panels of the tablet case 102. A user would then insert their tablet computer 104 into the middle panel of the tablet case 102, behind the frame, securing the tablet computer 104 in place via the elastic border. The other two panels would then be folded backward behind the table computer 104 and secured together. The tablet case 102 and tablet computer 104 would then be positioned on the front surface 106 of the protective bag 100 and secured via elastic straps and/or hook and loop fasteners. The tablet case 102 is secured on the front surface 106 of the protective bag 100 such that the tablet computer 104 can be viewed and utilized by the user 500.

The flap 120 can then be folded over the top portion 112 and the front surface 106 to conceal the tablet computer 104 from view, and the flap 120 can then be secured to the front surface 106. Once secure, the protective bag 100 containing the tablet computer 104 can be transported by the user 500 via the strap 122 (as shown in FIG. 5A).

If desired, the user 500 could unfold the legs 300 from the back surface 108 of the protective bag 100 and position the legs 300 such that the protective bag 100 remains upright when placed on a horizontal surface, such as a table. Once in position, the user 500 can utilize the tablet computer 104 while it is still attached to the protective bag 100.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective bag for securing and transporting an electronic device, comprising:
a front surface;
a back surface;
two side panels;
a top portion; and
a bottom portion; and wherein the front surface retains the electronic device such that the electronic device can be viewed by a user.

2. The protective bag of claim 1, wherein the electronic device is a tablet computer.

3. The protective bag of claim 2, further comprising a detachable tablet case for housing the tablet computer.

4. The protective bag of claim 3, wherein the detachable tablet case comprises at least one panel, and wherein the at least one panel comprises a frame and the tablet computer is positioned behind the frame.

5. The protective bag of claim 4, wherein the detachable tablet case comprises a middle panel and two front panels, wherein the middle panel comprises a frame and the two front panels fold over a front of the tablet computer or fold behind the tablet computer.

6. The protective bag of claim 5, wherein the frame comprises an elastic border for retaining the tablet computer behind the frame.

7. The protective bag of claim 6, wherein the front two panels are secured in front of or behind the tablet computer via hook and loop fasteners.

8. The protective bag of claim 1, further comprising a flap that folds over the top portion and the front surface to conceal the electronic device from view.

9. The protective bag of claim 1, wherein the bottom portion comprises a compartment for housing a battery pack or universal serial bus (USB) port.

10. The protective bag of claim 1, further comprising elastic bands and hook and loop fasteners to secure the electronic device to the protective bag.

11. The protective bag of claim 1, wherein the back surface comprises at least one leg that allows the protective bag to stand upright when in use.

12. The protective bag of claim 11, wherein the at least one leg folds into the back surface for storage and folds out when in use.

13. The protective bag of claim 11, further comprising a strap for transporting the protective bag.

14. A protective bag for securing and transporting a tablet computer, comprising:
a front surface, a back surface, two side panels, a top portion, and a bottom portion; and
a detachable tablet case for housing the tablet computer; and
wherein the detachable tablet case is configured to be positioned on the front surface of the protective bag such that the tablet computer can be viewed by a user.

15. The protective bag of claim 14, wherein the detachable tablet case comprises at least one panel, and wherein the at least one panel comprises a frame and an elastic border, and the tablet computer is positioned behind the frame and secured behind the frame via the elastic border.

16. The protective bag of claim 15, wherein the detachable tablet case comprises a middle panel and two front panels, wherein the middle panel comprises a frame and the two front panels fold over a front of or a back of the tablet computer.

17. The protective bag of claim 14, further comprising a flap that folds over the top portion and the front surface to conceal the tablet computer from view from outside the bag.

18. The protective bag of claim 14, further comprising elastic bands and hook and loop fasteners to secure the tablet case to the protective bag.

19. The protective bag of claim 14, wherein the back surface comprises at least one fold-out leg that allows the protective bag to stand upright when in use.

20. A protective bag for securing and transporting a tablet computer, comprising:
a front surface, a back surface, two side panels, a top portion, and a bottom portion; and
a detachable tablet case for housing the tablet computer; and
wherein the detachable tablet case comprises a middle panel and two front panels,
wherein the middle panel comprises a frame, and the tablet computer is positioned behind the frame, and the two front panels fold over a front of or a back of the tablet computer;
and
wherein the detachable tablet case is configured to be positioned on the front surface of the protective bag such that the tablet computer can be viewed by a user; and
wherein the protective bag comprises elastic bands and hook and loop fasteners to secure the tablet case to the protective bag.
